(19) United States
(12) Patent Application Publication
(10) Pub. No.: US 2005/0273364 A1
(43) Pub. Date: Dec. 8, 2005

(54) Patient centered process for the delivery of chronic and preventive medical care

(76) Inventor: Michael Franz Raab, Sanibel, FL (US)

Correspondence Address: Michael F Raab, 551 Hideaway Court, Sanibel, FL, 33957, US

(21) Appl. No.: 10/859,715

(22) Filed: Jun. 3, 2004

(51) Int. Cl. G06F 17/60

(52) U.S. Cl. 705/3

(57) ABSTRACT

It has been long noted that there is a shift in patterns of disease toward chronic illness. This shift necessitates a process that will support and encourage involvement of the patient in their own care, improve coordination of treatment among multiple providers, use reminders to keep preventive medicine and screening programs up to date and provide the up-to-date clinical information needed for treatment planning. There currently exists no process that does this using a patient centered approach. The Patient Personal Medical Record creates and supports a patient centered process that can be used in a variety of paper-based and electronic formats to improve coordination of treatment among multiple providers, remind patients of the need to stay up-to-date with preventive medicine programs and provide a method to supply the up-to-date clinical information needed for treatment planning.

### FIELD OF INVENTION

DELIVERY OF CHRONIC AND PREVENTIVE MEDICAL CARE.

### TECHNICAL FIELD OF INVENTION

The present invention pertains to processes to organize the delivery of medical care. It is recognized that the current processes are designed and based on the needs relating to the delivery of acute care. Thus, there is a need for a process to address managing chronic care and improve the delivery of preventive care.

### FEDERAL R & D:

There has been no Federal sponsorship of this invention.

### REFERENCE TO RELATED APPLICATIONS

### REFERENCE CITED

U.S. Pat. No. 6,725,200 Rost Apr. 20, 2004

Personal data archive system

Abstract

The invention concerns a personal data archive system with portable personal storage devices allowing the owner to enter and store personal data. Authorization checking devices are allocated to the storage devices and grant access to at least some of the personal data stored in the storage devices only in the event of a positive authorization and/or authentication.

U.S. Pat. No. 6,154,726 Rensimer, et al. Nov. 28, 2000 System and method for recording patient history data about on-going physician care procedures

Abstract

A system and method for processing patient data permits physicians and other medical staff personnel to record, accurately and precisely, historical patient care information. An objective measure of a physician's rendered level of care, as described by a clinical status code, is automatically generated.

U.S. Pat. No. 6,234,964 IIiff May 22, 2001

Disease management system and method

Abstract

One aspect of the invention is directed to a system and method for automated knowledge-based, long-term patient disease management. Disease management is directed to the continuing medical care of a patient who has been diagnosed with a specified health problem called a disease.

U.S. Pat. No. 5,827,180 Goodman Oct. 27, 1998

Method and apparatus for a personal health network

Abstract

A method and system for a health network comprising a facility, operated by a party other than the patient or health care provider, for collecting and routing information pertaining to the health care of a patient to the patient and the health care provider.

U.S. Pat. No. 5,822,544 Chaco, et al. Oct. 13, 1998

Patient care and communication system

Abstract

A patient care and communication system which utilizes a central processing system and a plurality of remote stations electrically connected to the central processing system to facilitate audio, visual and data communications.

### BACKGROUND OF THE INVENTION

The current process for the delivery of health care has not been able to keep patients with chronic illness up-to-date with preventive cancer screening nor has it been able to keep the majority of adult diabetics up-to-date with the testing needed for optimal management. These outcomes are felt to reflect the bias of an organizational system based on treatment of acute disease, which does not lend itself to managing chronic illness or providing preventive care. Therefore, there is the need to develop processes to accommodate the proactive, planned, patient oriented, longitudinal care required for both preventive and chronic care. This process will need to integrate an emphasis on wellness, prevention, education, coordination of resources and reflect the increasing role of self-care in treatment and prevention. This process should also improve the availability of clinical information at the time of a patient's visit.

### SUMMARY OF THE INVENTION

The Patient Personal Medical Record provides the necessary support to create a process for the delivery chronic and preventive care. It is a designed to be carried, kept up-to-date and reviewed by the patient thus involving them in their care. It contains information about the care of all providers, a combined list of the preventive tests all the providers require and copies of all test results as soon as they are available. Because it is carried by the patient to all their doctor visits it improves coordination among providers and makes the most recent clinical data readily available at the time of the patient visit. The Patient Personal Medical Record could be created in electronic or paper form in a variety of formats. The essential aspect is the ability to support and encourage patient involvement in their care, remind patients of the need to stay up-to-date with their preventive treatments (immunizations) and tests, provide a place for patients to store their information and be portable so the information moves with the patient as they go from doctor to doctor, hospital to office and even state to state.

### BRIEF DESCRIPTION OF DRAWINGS

For a more complete understanding of the process relating to the present invention reference is made to the accompanying figures.

FIG. 1 illustrates a preprinted page with labeled blanks for patients to fill in information at each provider encounter.

FIG. 2 illustrates a preprinted page with labeled blanks for patients to fill in useful information relating to the medications a patient is taking.

FIG. 3 illustrates a preprinted page with information and blanks for patients to be reminded of the need for immunizations and record the dates they are done.

FIG. 4 illustrates a preprinted page with labeled blanks to record information relating to treatments a patient is having or has had in the past.

FIG. 5 illustrates a preprinted page with information suggesting screening tests, blanks for physicians to add additional tests the patient should have and blanks for patients to keep track of when the tests are done. The information on this page also serves as a reminder for the patient to keep up-to-date with these tests.

FIG. 6 illustrates a preprinted page with reminders of the need to complete advance directives and blanks for patients to fill in information that would be useful if the patient became unable to express their wishes or in an emergency.

FIG. 7 illustrates a preprinted face page with labeled blanks to prompt a patient to fill in medical information that would be useful in an emergency.

FIG. 8 illustrates a preprinted page with labeled blanks for patients to fill in information that would be useful as a reference base for a provider's office.

### DETAILED DESCRIPTION OF INVENTION

The Patient Personal Medical Record, hereafter referred to as PPMR, provides a framework and support for a process to improve chronic and preventive care. This process encourages involvement of the patient in their own care, improves coordination of treatment among multiple providers, uses reminders to help patients keep preventive medicine and screening programs up-to-date and provides a method to make current clinical information available at the time of each patient doctor visit to aid treatment planning. The PPMR does this by organizing the delivery of the patient's care into four areas.

(I) Who They See for Their Care.

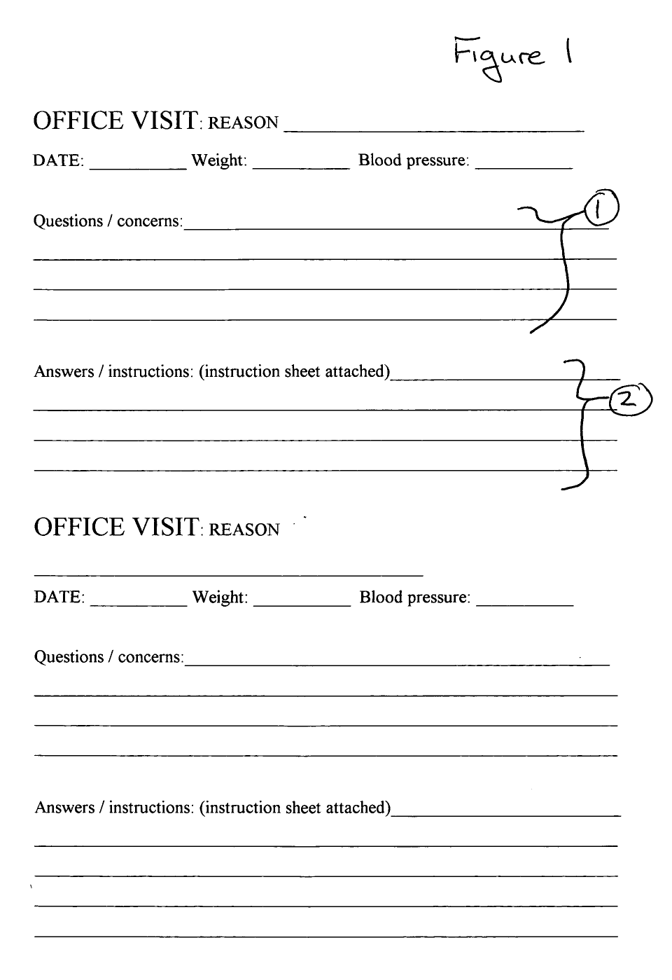

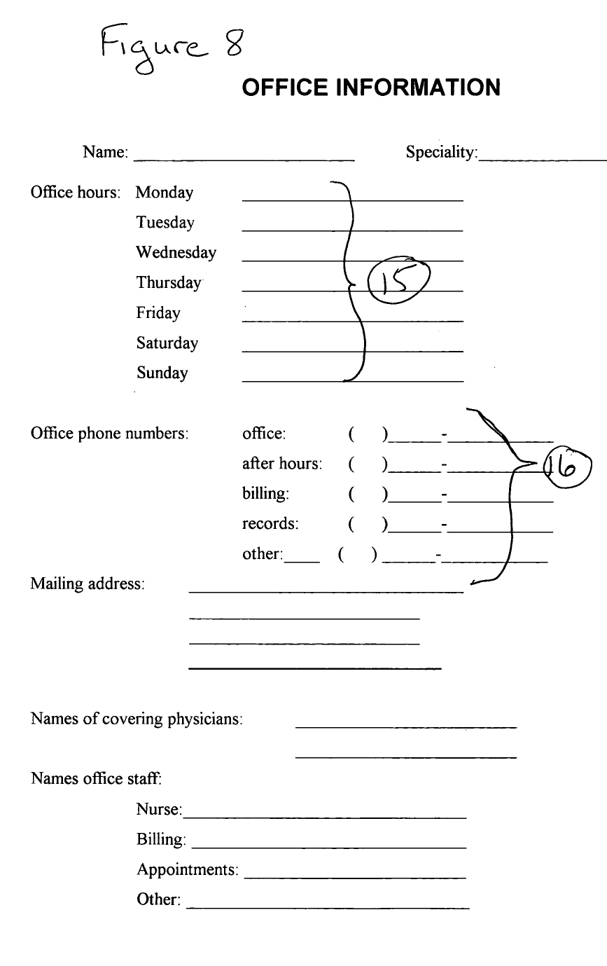

This includes physicians, therapists, nurse clinicians and any others the patient sees regarding their health. The PPMR creates a section (in a paper form) or folder (in an electronic form) for each provider and uses preprinted pages(in a paper form) or formats (in an electronic form), examples of the categories of information on the preprinted pages are shown in FIG. 1 and FIG. 8—although recording different information or using a different format would not alter the process claimed. Patients are instructed to look through their PPMR prior to their office visit and write down questions they may have regarding their care. The PPMR thus not only encourages patients to become involves but supports this goal by providing a place 1 for them to write down their questions. Patients are also instructed to also write down the answers 2 they receive which further involves them in their care and helps be sure they understand the instructions thus improving communication with their physician.

The patient is instructed to carry the PPMR and use it at all health related visits. This makes it available for each healthcare provider they see thus decreasing fragmentation and improving continuity and coordination of care.

(II) What Things They do Now, Have Done and Should do for Their Health.

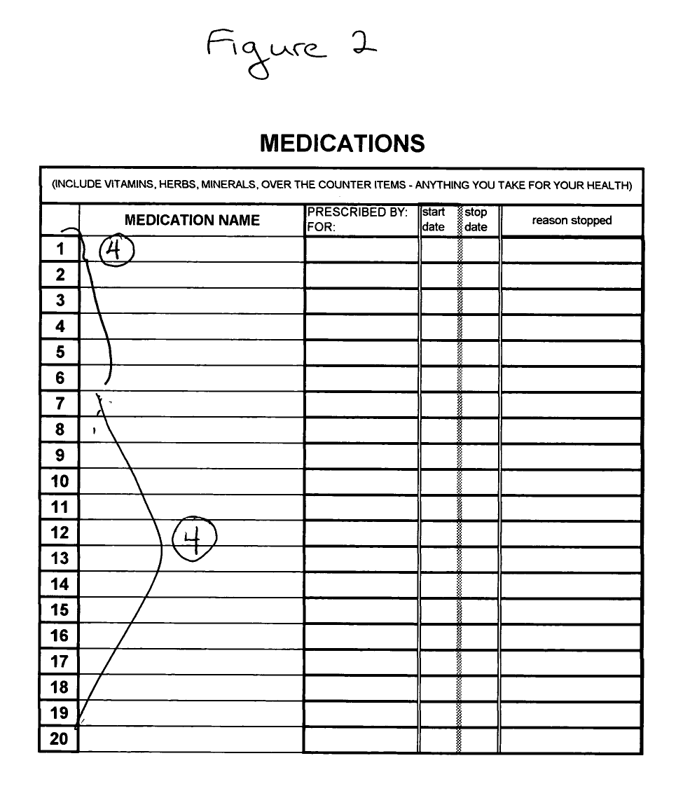

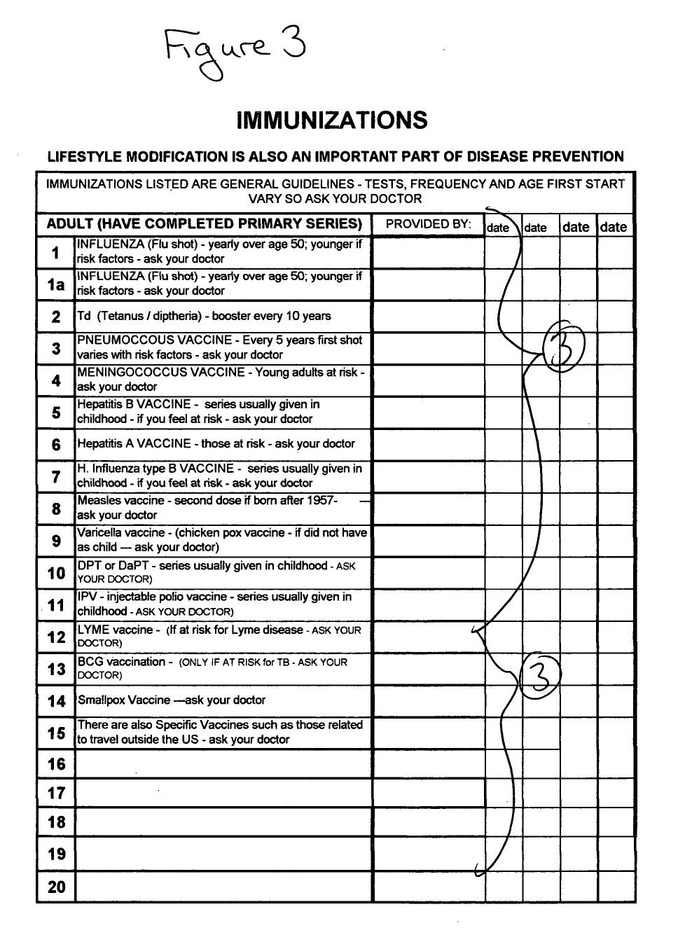

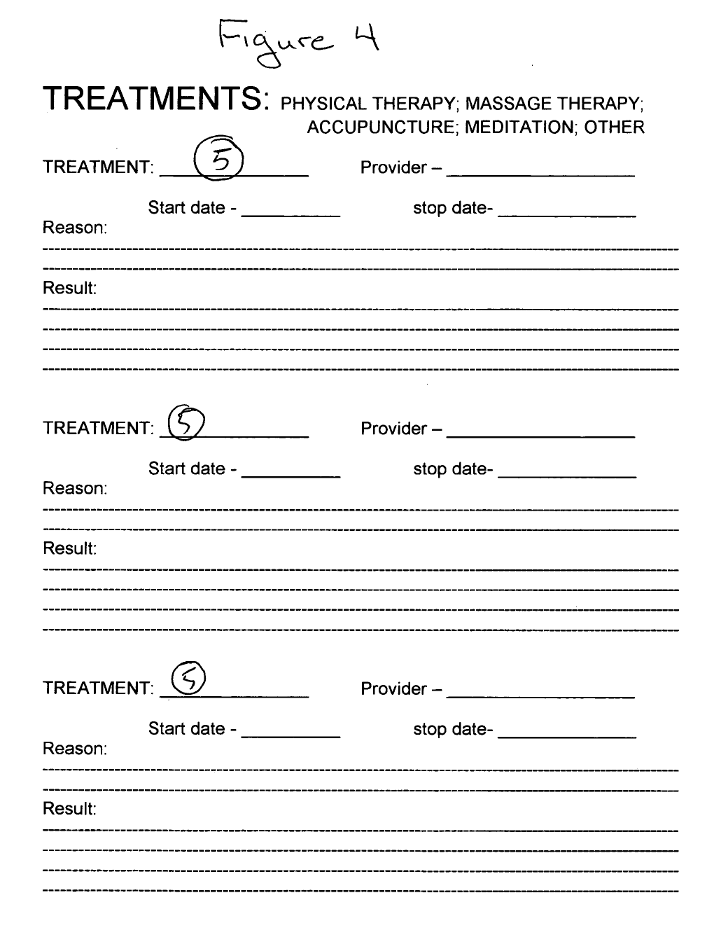

The PPMR creates a section (in a paper form) or folder (in an electronic form) for patients to keep track of immunizations 3, medications 4, herbs 4, vitamins 4, acupuncture 5, physical therapy 5 and anything else they do for their health. This section uses preprinted pages (in a paper form) or formats (in an electronic form) such as those shown in FIG. 2, FIG. 3 and FIG. 4. Again the graphic design and information preprinted on the pages can vary without altering the intent of the invention which is to provide a format for patients to use making it easier for them to create an on going summary of the things they do for their health. This section of the PPMR supports patient involvement by helping them know what information to keep and providing a place to keep this information up-to-date. The portable PPMR is carried from doctor to doctor again reinforcing and assisting the patient in becoming involved in their care as well as helping coordinate the care of their doctors and other health care providers.

(III) What Screening and Other Preventive Testing They Need.

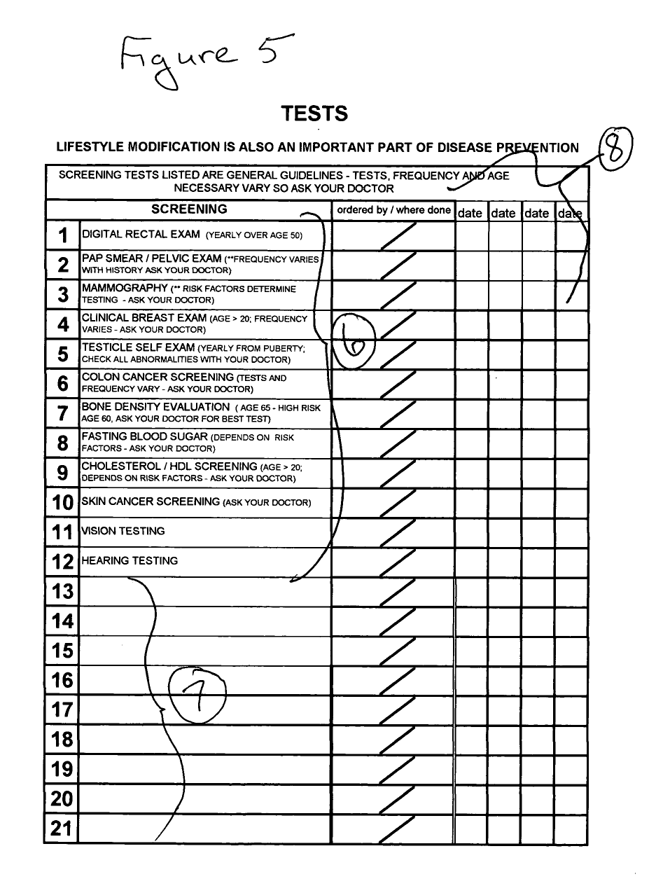

A third important part of the process is the need to keep a patient up-to-date with screening and disease monitoring tests, as well as having this clinical information available to providers at the time of each encounter. The PPMR creates a section (in a paper form) or folder (in an electronic form) for tests. FIG. 5 is an example of the type of preprinted page (in a paper form) or format (in an electronic form) that can be used to serve as a reminder to patients of what tests they should have done on a regular basis. There is a list of recommended 6 screening tests. There are blanks 7 so tests suggested by any or all of their physicians can be added. This creates one place for all testing recommended by all providers. The patient is reminded of these tests when they review the PPMR prior to each doctor visit and given a place to record the date the test is done 8. The doctors all see the list to insure it is complete. The patient is instructed to obtain copies of all the tests they have and store them in this section. This accomplishes a fourth important part of the process by making current clinical information available at the time of each routine doctor visit as well as in the case of the need to go to the emergency room.

(IV) What are the Personal Preferences for Future Care.

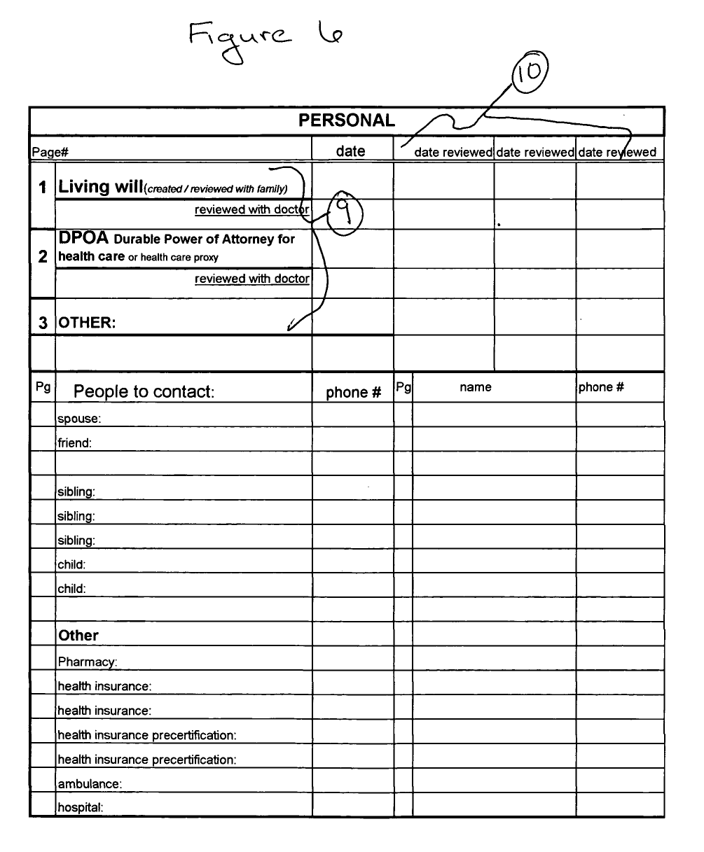

A fifth important part of the process to involve patients is to empower them regarding their own care. This is done using advance directives where patients record their wishes should they become unable to speak for themselves and appoint a surrogate to speak for them. This is done through the use of various forms of living wills and a durable power of attorney. FIG. 6 is a page (in a paper form) or format (in an electronic form) to serve as a record of the presence of advance directives 9 and a reminder that they need to be kept up-to-date 10. This page also has blanks that can be used for patients to write down other information they may want to keep handy in case of emergency. 11

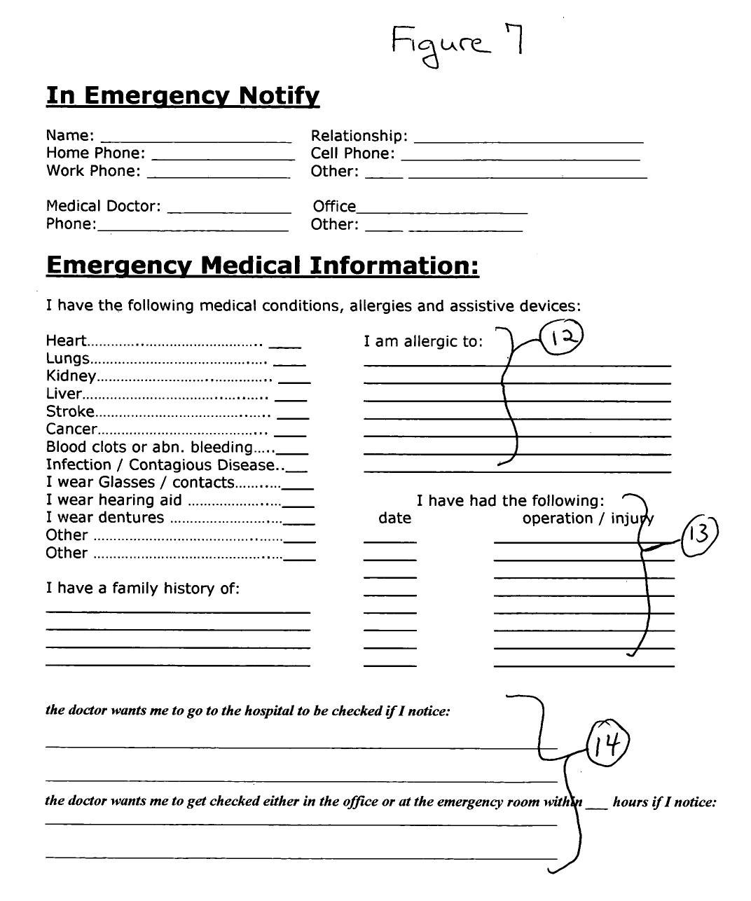

Creating a portable medical record can be made more complete by including information needed in case of emergency. FIG. 7 is a page (in a paper form) or format (in an electronic form) that can be used as a face sheet to provide such information including allergies 12, prior surgery 13 and specific information from the physician to clarify to the patient what symptoms are significant and should prompt medical evaluation.14

Creating a portable medical record with information from a variety of caregivers can be made more complete by providing a space for information regarding each caregiver. FIG. 8 is a page (in a paper form) or format (in an electronic form) that can be used to provide information specific to each provider such as office hours 15 and business phone numbers.16

1. A patient centered process to improve the delivery of chronic and preventive care that is supported by a patient held medical record. This record is designed to prompt the patient regarding the type of information to gather, hold and carry to all their health care visits. Currently medical records are the property of the physician, therapist or other provider, thus even if a patient had copies of these records they would not serve to involve the patient in their own care. The process used by the PPMR form of patient held record involves the patient in their care by giving them an essential role in maintenance of the record.

2. A patient centered process that improves preventive care and continuity of care by providing reminders regarding immunizations, screening and other tests and a longitudinal record of medications and treatments. Patients, physicians and other healthcare providers are encouraged to review this information, which is a summary from all providers, on a regular basis. This serves to keep patients up-to-date with preventive care and decrease care redundancy and fragmentation between various providers.

3. A process to assist patients in making current clinical information readily available to providers during patient—physician encounters when providers are making treatment decisions. The patient is given a mechanism to review and keep up-to-date all tests with a mandate to collect and a place to store the test results. The patient then is carrying this information with them insuring it is available.

4. A process to involve patients in their care. This is done by giving them control of and responsibility for their information. Having patients carry the information with them and encouraging them to reviewing it before each encounter allows them to ask questions so they understand their care, something that improves compliance leading to better outcomes.

5. A process to improve the quality of doctor visits. This is accomplished using the PPMR as it assists the patient preparing for the doctor visit by having their medical information in a summary form for review and helping patients to generate questions to clarify what they should be doing for their care. Keeping the advise from all providers available to each provider decreases fragmentation of care. Knowing when tests are done and having copies of the results available means the providers are able to spend more time caring for the patient and less time searching for these results. The provider also has up-to-date clinical information needed for planning improving their ability to make treatment decisions.
Variations in the specific number of pages (in a paper form) or formats (in an electronic form) or the information imprinted on each does not alter the process or the intent of this invention to provide a patient centered process for the delivery of chronic and preventive care which is the claim of this invention. Carrying the information in an electronic form such as on a memory storage devise, lap top computer or any other devise instead of the paper form does not effect the process or function of this invention as an improved process to accommodate the need for proactive, planned, patient oriented, longitudinal care required for both preventive and chronic medical care.
